(19) United States
(12) Patent Application Publication
(10) Pub. No.: US 2011/0156910 A1
(43) Pub. Date: Jun. 30, 2011

(54) Method for the Securing and Monitoring of Containers and Container with Securing and Monitoring Device

(76) Inventors: Norbert Pieper, Koblenz (DE); Rainer Henss, Altenstadt (DE); Michael Schmidt, Windhaqen (DE)

(21) Appl. No.: 11/794,841

(22) PCT Filed: Jun. 21, 2005
(86) PCT No.: PCT/EP05/06680

§ 371 Date: Feb. 9, 2008

(30) Foreign Application Priority Data
Jan. 6, 2005 (DE) 10 2005 001 118.7

(51) Int. Cl. G08B 13/14

(52) U.S. Cl. 340/572.7

(57) ABSTRACT

A method of monitoring a container that holds goods, in which one or more surfaces of the container have an electrically conductive material that acts as a sensor to detect state changes in physical properties of the container, comprises obtaining state information from the electrically conductive material and determining a position of the container. The method further comprises associating the state information with the position of the container, detecting data about the goods from an RFID tag located on the goods via an antenna that is installed around the opening edge of the container when the goods are loaded into the container and passed by the antenna, and transmitting at least one of the state information, the position of the container or the data about the goods to a data processing unit.

### CROSS REFERENCE TO RELATED APPLICATIONS

This application is a continuation of International Patent Application No. PCT/EP2005/006680, filed on Jun. 21, 2005, the contents of which are incorporated by reference as if set forth in their entirety herein, which claims priority to German (DE) Patent Application No. 10 2005 001 118.7, filed Jan. 6, 2005, the contents of which are incorporated by reference as if set forth in their entirety herein.

### BACKGROUND

The invention relates to a method for monitoring a container for holding goods, in which one or more surfaces of the container are provided with an electrically conductive material, whereby the material serves as a sensor means for ascertaining state changes in the physical properties of the container material, and a data processing unit on the container obtains this state information from the sensor means.

The invention also relates to a container for holding goods and for carrying out the method according to the invention.

In the realm of the transportation of goods within logistics systems, there is a need to adequately secure the transportation containers and thus the goods contained therein against damage, theft or other undesired influences. In order not to have to use any intricately secured and heavy containers, the containers are normally monitored during transportation.

Damage to the transported goods can occur, for example, if the goods are not transported at certain ambient conditions such as temperature, air composition or humidity, with the result that especially foods or drugs are not transported under the requisite optimum conditions. Therefore, for the operator of a transportation and logistics system, it is advantageous if the ambient conditions of such goods in a container can be monitored and recorded. In some cases, the monitoring allows a direct influencing of the conditions of the transportation container.

A system for monitoring containers in which the ambient state is monitored and controlled in the containers that hold goods like fruit and vegetables that spoil easily is known, for example, from German Preliminary Published Application DE 195 34 948 A1. The system involves the placement of state monitoring devices in the containers that are in communication with a monitoring center via a phone, radio or satellite connection. The disclosed system also affords theft protection in which the position of a container is detected, for example, by a satellite positioning method such as GPS. If the position diverges from a prescribed target position, an alarm with various follow-up scenarios can be triggered.

Particularly for purposes of verifying the integrity of a transportation container, it is also advantageous to continuously record and log the state of a transportation container. In the postal shipping sector, packaging such as envelopes or parcels are known whose surfaces are completely or partially coated with several conductive strips. For this purpose, European patent application EP 1 122 698 A2 discloses, for example, packaging with means for checking the integrity of the packaging. The packaging is provided with conductive strips and with a control module, so that damage to the packaging interrupts the electric circuit of the strips and this is detected as damage. The occurrence of damage can be written into a memory, and this information can be augmented, for example, by the place of the damage on the packaging, the date, the time and the position of the packaging within the transportation system. This information can be read out via an interface and further processed.

International patent application WO 2004/078787 A1 likewise discloses packaging that is coated with a conductive ink in order to ascertain damage. In addition to a means to detect the occurrence of physical damage to the packaging material, the packaging also has a temperature sensor that measures the temperature inside the packaging. The temperature value is stored and can likewise be read out at a later point in time via an interface.

Particularly during the transportation of valuable goods, there is a risk that the goods will be stolen from the transportation containers, whereby the goods can be removed from the containers during the actual transportation or at various intermediate stops. Therefore, for a commissioned shipping company, it is desirable to be able to demonstrate that a container holding goods within a certain shipping order was not opened and, if applicable, that certain specifications were complied with. If an unwanted event occurs to the container, this should be recorded promptly.

### SUMMARY OF THE INVENTION

Therefore, the objective of the invention is to provide a container for transporting goods that allows monitoring of the transportation of goods and that is improved over the prior-art containers.

It is also the objective of the invention to provide a method for monitoring containers that hold goods.

The method according to the invention for monitoring a container for holding goods provides that one or more surfaces of the container are provided with an electrically conductive material, whereby the material serves as a sensor means for ascertaining state changes in the physical properties of the container material. A data processing unit on the container obtains this state information from the sensor means. The method is characterized in that a positioning means in communication with the container determines the position of the container and the position of the container is associated with the state information obtained from the sensor means. In this process, the position of the container can be determined by means of a positioning means located directly on the container or on a transportation means with which the container is being transported. If the positioning means is on an associated transportation means, it is preferably in communication with the data processing unit of the container.

The position of the container can be determined, for example, by a positioning means in the form of a GSM module, a GPS module and/or a direction-finding transmitter. The various positioning means can be used as a function of the requisite precision of the position determination, whereby they can be used alternately or in parallel.

The method proposes that for the state information obtained from the sensor means to be compared to target values, whereby a deviation from a target value is considered to be an alarm. The comparison of the state information is preferably carried out by comparing the measured electrical properties of the conductive layers to a target value for the electrical properties. Here, it can be provided that if the physical properties of the container material detected by the sensor means deviate from a target value, this is not considered to be an alarm if the deviation is associated with a position of the container that is stored in the data processing unit as a position in which it is permissible to open the container.

In an especially preferred embodiment of the invention, the state information obtained from the sensor means is transmitted to a communication module on the container, and the communication module transmits the state information to a message receiving device. The communication module is preferably a GSM module. The state information can be transmitted from the communication module to the message receiving device during transportation or once the container has arrived at the destination. Preferably, the state information is only transmitted during transportation if a comparison within the data processing unit shows that a deviation from target values of the state information acquired by the sensor means is considered to be an alarm.

The determination of the position of the container and the association of the position with the state information obtained from the sensor means are preferably carried out in the data processing unit of the container, but it can also be carried out in the message receiving device or in the monitoring center.

In an especially preferred embodiment of the invention, the container is provided with an atmosphere measuring device that detects the atmosphere inside the container and then the measured values from the atmosphere measuring device are transmitted to the data processing unit of the container. This atmosphere measuring device can be, for example, a temperature and/or moisture sensor whose measured values are transmitted to the data processing unit of the container.

Another embodiment of the invention proposes for the container to be provided with a goods detection means for recording the goods held in the container and then data about the detected goods is transmitted to the data processing unit. An example of a goods detection means is an antenna that is installed around the opening edge of the container. The goods are recorded by reading out the RFID′ tags located on the goods while the RFID tags are being moved past the antenna when the goods are placed into the container. The container can also be provided with a group detection device that detects the goods once all of the goods have been placed into the container.

When the goods are detected, at least the number of items that have been placed into the container are recorded in the data processing unit. Here, an item removed from the container reduces the number of items recorded in the data processing unit, whereby the procedure of removal of an item from the container is recorded in that the number of procedures in which the unambiguously identifiable RFID tag was detected is an even number.

In addition to the number of items placed into the container, preferably further data about the goods is also acquired. In an especially preferred embodiment of the invention, the number of recorded items and/or further data about the recorded items are transmitted from the data processing unit to the communication module, which then sends the information to a message receiving device. The message receiving device can be located, for example, in the area of the receiver of the goods or in the area of a monitoring center.

In addition to a method for monitoring a container, the invention also comprises a container having means for the monitoring according to the invention. The container for holding goods calls for sensor means made of conductive strips that serve to ascertain state changes in the physical properties of the container. The container also comprises a data processing unit and a positioning means for determining the position of the container in communication with the container. Preferably, the container has a communication module that is in communication with the data processing unit and an atmosphere measuring device such as a temperature and/or moisture sensor. In an especially preferred embodiment of the invention, the container also has a protective sheathing. Another advantageous embodiment of the container has a goods detection means for recording at least the number of items placed into the container.

The method according to the invention has the advantage that the state of a container can be comprehensively monitored during the transportation of goods. Techniques for measuring and monitoring the physical properties of a container material and/or of the ambient conditions can be used together with a positioning means in order to associate a position of the container with an event involving the container or with a state. This allows the precise determination of the location and thus, for example, the area of responsibility in which an event occurred.

If several positioning means with differing precisions are employed, they can be used as a function of the requisite precision range. It is especially advantageous here to use a communication module that can send acquired data to a monitoring component either continuously or in case of an alarm.

In order to already start the monitoring when a container is being filled, it is advantageous to use a goods detection means that allows the recording of all of the items in the container. A position of the container in question can, in turn, be associated with this information and the communication module can be used to send the data to different message receiving devices. In this manner, a log can be created indicating that the goods intended for transportation were actually placed into the container and that any theft that may occur can only happen during transportation.

This is especially advantageous for the shipper of a container that holds goods since, together with the state sensors and the positioning means, any undesired event involving the container can be tracked without there being a need to take into account any uncertainties about the con-tent of the container before the transportation procedure.

### BRIEF DESCRIPTION OF THE DRAWINGS

The figures show the following:

FIG. 1 is a schematic depiction of an exemplary embodiment of the container according to the invention;

FIG. 2 is a block diagram of an exemplary embodiment of a container with protective sheathing; and

FIG. 3 is a block diagram of an embodiment of a container with capability for recording the goods.

### DETAILED DESCRIPTION OF SPECIFIC EMBODIMENTS

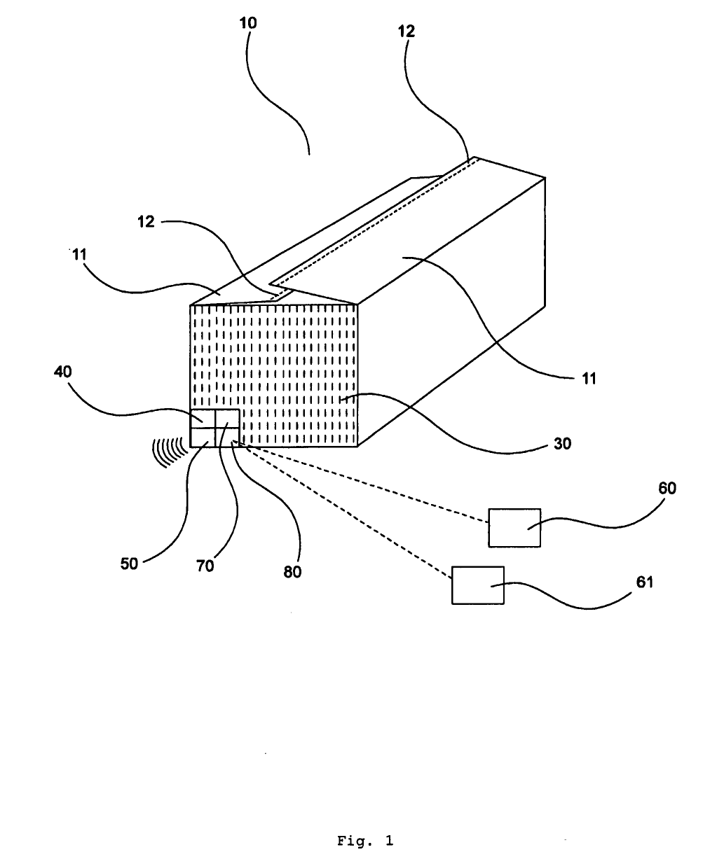

The container 10 schematically shown in FIG. 1 for holding and transporting goods can be, for example, a cuboidal container with a bottom surface, four side walls and a lid arrangement. The container can be made of various materials such as cardboard, wood, plastic, metal or combinations thereof. If a soft material such as cardboard is used, it can be practical to provide the cardboard box with protective sheathing 100 which completely encloses the container. This protective sheathing can likewise be made of plastic, wood or metal.

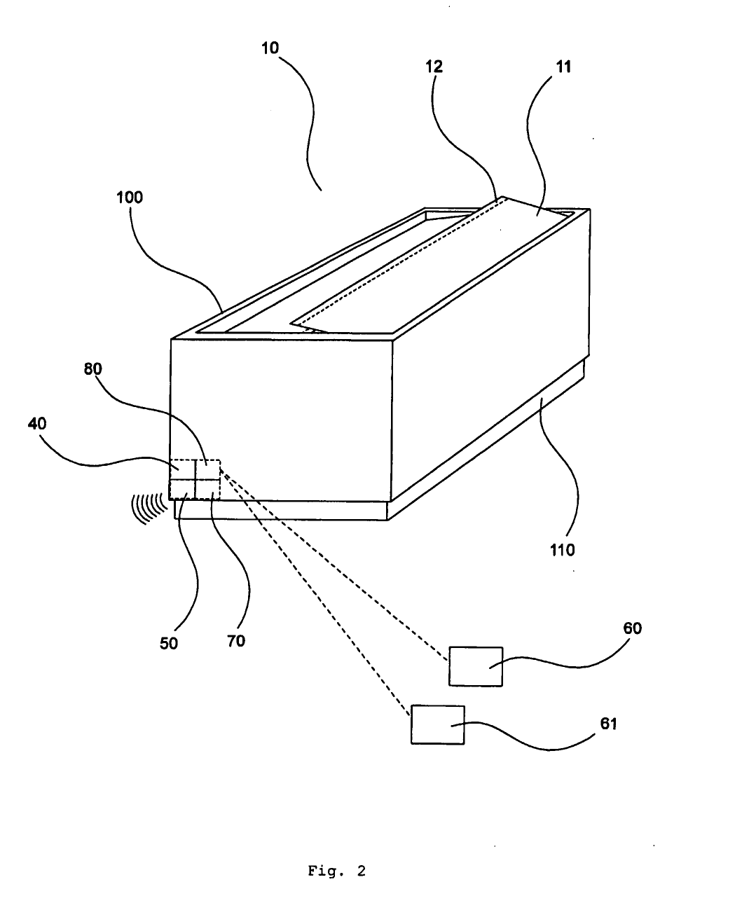

Such a container with protective sheathing is shown by way of example in FIG. 2. In an especially preferred embodiment of the invention, the protective sheathing 100 comprises a pallet bottom 110 made of wood and side walls as well as a lid made of rigid plastic. The bottom 110 is configured as a conventional pallet and permanently or detachably joined to the side walls made of rigid plastic. The protective sheathing 100 can be permanently joined to the base container 10, although it has proven to be advantageous to configure the protective sheathing 100 so that it is detachable from said container. In this manner, the base container can be transported over portions of the transportation route in such a way that it is protected by the sheathing, whereas the container can be conveyed or stored without any protective sheathing along other transportation routes where no additional protection is necessary. Moreover, in this way, the protective sheathing 500 is reusable and can be used for a large number of transportation runs, even if the base container 10 is damaged and can no longer be used.

Preferably, all of the wall surfaces of the container 10 are provided with surfaces made of electrically conductive material that serves as a sensor means 30 for ascertaining state changes in the physical properties of the container material. For this purpose, parts of the surface or else the entire surface of the container can be coated with conductive material. Preferably, the container surface is provided with several conductive strips in the form of electronic ink that are printed directly onto the container material or onto a polymer film coating. For the sake of simplicity, FIG. 1 shows only the front side wall of the container with conductive strips 30. The conductive strips are arranged in such a way that a physical change in the properties of the container material and thus damage to the container material causes a change in the electrical properties of the strips.

In order to evaluate the state information acquired by the sensor means, the conductive strips 30 are connected to a data processing unit 40 that is in communication with the container 10. Advantageously, the data processing unit has at least one source of voltage, a computer means for processing data and a memory. The unit is preferably located directly on or in the container 10. In order to protect the unit from unauthorized access, the individual components can be integrated, for example, into the container material.

The conductive strips 30 of the container can be used in various ways as sensor means for monitoring the properties of the container material. For instance, the resistance of the strips can be continuously measured, and a fluctuation in the resistance is considered to be damage to the container material. Since this entails the risk that the monitoring might be manipulated if the strips are bridged, it has proven to be practical to carry out the monitoring of an analog resistance value. Here, it is advantageous to use reference strips in order to account for natural changes in the resistance, for example, due to aging, moisture or temperature influences. If a deviation from the target value set by the reference strips is measured, then this is recorded as damage to the container material and, optionally, as an alarm.

In order to record not only damage to the container material, for example, as a result of cuts, but rather also the opening of the container lid, various lid arrangements can be provided. If in an application area it is merely necessary to record the one-time opening of the lid, then this can be achieved, for example, in that the conductive strips 30 likewise extend into the area of the container lid surfaces 11. As is known from the state of the art used for the monitoring of envelopes, it can be provided for the closure surfaces to be configured in such a way that the conductive strips 30 adhere slightly to the container material whereas they adhere strongly to the closure materials like adhesive tape. For example, the closure of a container lid 11 made of cardboard can be configured in such a way that two or four lid surfaces are folded over and connected to each other. Such a lid with two visible lid surfaces is shown in FIG. 1. The lid surfaces 11 are preferably connected to an adhesive tape (not shown here) that is applied onto areas of the surfaces to which the conductive strips only adhere slightly. As a result, the adhesive tape cannot be removed to open the lid without the conductive strips underneath them also being detached, as a result of which a resultant change to the electrical properties of the strips is recorded.

In another embodiment of the invention, overlapping lid surfaces 11 are provided with capacitive connection surfaces 12 that extend, for example, along the edges of the lid surfaces, as shown in FIG. 1. When the lid is closed, two connection surfaces lie on top of each other, so that the two connection surfaces 12 form a capacitive element with a relatively high capacitance. If the lid is opened, the distance between the connection surfaces 12 increases and the capacitance drops markedly. The connection surfaces are likewise in communication with the data processing unit 40 and the drop in the capacitance can be recorded as an opening of the lid.

A lid arrangement with capacitive connection surfaces 12 has the advantage that no fixed closure using adhesive tape is required and moreover, that opening and closing multiple times can be recorded without the lid closure being destroyed in the process. Goods 20 can thus be removed from or added to the container if authorization has been given for this, whereas unauthorized procedures are recorded.

An essential component of the invention is that the container 10 is in communication with a positioning means in order to determine the position of the container. The positioning means 50 is preferably situated directly on the container, but it can also be situated on a transportation means with which the container is transported. For example, the positioning means can be situated on an airplane, truck or ship on which the container is conveyed.

The positioning means can be, for example, a direction-finding transmitter, a GSM module or a GPS module. The direction-finding transmitter is mounted onto the container or onto an associated transportation means and can be located by a remote station. In this case, the information about the position of the container is not available to the data processing unit 40, so the direction-finding transmitter is advantageously augmented by another module such as a GPS (Global Positioning System). When a GPS positioning procedure is used, its current position can be transmitted to the appertaining satellite receiver so that the position of the container is available to the data processing unit 40. This likewise applies to a GSM module whose position is transmitted by means of cellular position determination. The use of a GSM module is also advantageous since it can concurrently be used as a communication module for sending information.

The positioning means cited by way of example can be used alternately or in parallel. In an especially preferred embodiment of the invention, at least two of the above-mentioned positioning means are used for determining the position of the container. This embodiment has the advantage that, owing to the various positioning techniques, the position of the container can be determined with a variable precision and, if necessary, also within closed spaces. For example, the direction-finding transmitter can be used in order to be able to determine the position of the container as precisely as possible, whereas position determination by means of GPS and/or GSM modules is sufficient for the determination within a larger area.

In another embodiment of the invention, the container 10 also has an atmosphere measuring device 70 with which the atmospheric conditions inside or on the container can be measured. The atmosphere measuring device is likewise in communication with the data processing unit 40. The measuring device can be, for example, a temperature or moisture sensor whose measured values are transmitted to the data processing unit 40.

The container also has a communication module 80 that is in communication with the data processing unit 40. The communication module 80 can be, for example, a PC interface for reading out data. However, special preference is given to the use of a GSM module with which messages can be sent and received within the GSM network. The communication module is configured in such a way that it can transmit data received from the data processing unit to a monitoring center 60 and/or to an alternative message receiving means 61. The monitoring center can be, for example, the central office of a transportation and logistics company that is transporting the goods held in the container. Additional message receiving means 61 can be situated at the premises of the shipper or of the recipient of the goods being transported, so that these stations can likewise receive messages from the container.

The described set-up of the container 10 with various sensors, a positioning means 50 and a communication module 80 allows monitoring of the container, whereby various parameters such as integrity, position and ambient conditions can be monitored. Here, all of the available or selected parameters can be monitored. The monitoring of the integrity of the container 10 is achieved by the sensor means 30 in the form of conductive surfaces, whereby the measured electrical properties of the sensor means are transmitted to the data processing unit 40. In this manner, it can be monitored whether a container has been cut open during transportation, for example, by sharp objects, so that goods could have been removed without authorization.

Moreover, it can be advantageous to monitor a planned route of the container and, for this purpose, to continuously determine the current position of the container by using the positioning means 50. Thus, it can be tracked whether a container has moved away from a prescribed route, which is a sign of an irregularity that might have to be checked or even of the theft of the goods held in the container. The determination of the position can especially serve to associate a position of the container with an alarm, indicating where an irregularity has occurred.

The monitoring of certain values for the temperature and/or moisture inside the container is done by an appropriate sensor 70, whose values are likewise transmitted to the data processing unit. Thus, for example, during the transportation of food or drugs, it can be monitored whether the requisite atmospheric conditions are maintained.

Methods for monitoring the container 10 can involve various types of alarms and responses to them. For example, it can be provided for the data acquired on the container to be stored in the data processing unit 40 and/or continuously transmitted via the communication module 80 to a monitoring center 60 or to an alternative message receiving means 61. In the case of just storage, the data can be read out and processed, for example, at the destination of the container via an interface. This can be done by connecting the communication module 80 to a receiving device, whereby the connection can be made via direct contact or remote transmission. For purposes of remote transmission, suitable communication means are, for example, RFID chips in the container, whose stored data can be read out.

The evaluation of deviations of the measured values from target values can likewise be carried out in the data processing unit 40 itself or in a separate evaluation unit. In the latter case, the data is read out, for example, at the destination, and an evaluation is made as to whether deviations from target states have occurred. This can be advantageous if a given application merely requires the determination as to whether a container was transported correctly and where damage may have occurred.

However, it is especially advantageous to monitor the container during the transportation so that, if necessary, a direct response to the alarm in question can be made. In this case, the communication module 80 transmits data about the container to the monitoring center already during transportation. Here, it can be advantageous for the data processing unit not to send a continuous data stream but rather for it to perform an evaluation of the measured state information and to trigger an alarm in case of deviations from target values. Only when an alarm is triggered is information about the state of the container sent to the monitoring center 60 and/or to alternative message receiving means 61. This notification preferably comprises the type of deviation from a target value and the associated position where the deviation occurred. If, for example, an alarm is triggered relating to the integrity of the container, the current position of the container is associated with this alarm and it is possible to check on site whether the container was damaged within the scope of theft.

The container according to the invention also allows further methods for verifying the authorized opening. For example, it can be programmed in the data processing unit 40 that the container may only be opened at a certain place. Consequently, when the container is opened, the position of the container currently determined by the positioning means 50 is compared to the stored place where the opening is authorized. If these positions match, the opening is recorded as being correct. If the comparison shows that the positions differ from each other, then this is considered to be an unauthorized opening of the container. Various tolerances for the deviation of a position can be programmed, whereby it is once again advantageous to use different positioning means with differing levels of precision. For example, a direction-finding transmitter can be used if the position at the time of the opening has to be accurate to within 1 meter. This is the case, for example, if a container in a building may only be opened in certain rooms. If a larger area is permissible for the opening, then positioning means that operate with less precision such as GSM or GPS modules are sufficient.

In another embodiment of the invention, the authorized opening of a container calls for an access code or for a release of the container. The access code can be entered by a user directly into the data processing unit. Especially advantageously, however, access control can be achieved in that the data processing unit 40 requests a release of the container, for example, by the monitoring center 60 or by alternative components. Once certain conditions have been fulfilled, the monitoring center sends, for example, an access code to the data processing unit 40 and the container can be opened without this being considered to be an unauthorized access. In this manner, it can likewise be achieved that the transmission of an access code by several components or users is required in order to authorize an opening of the container without triggering an alarm.

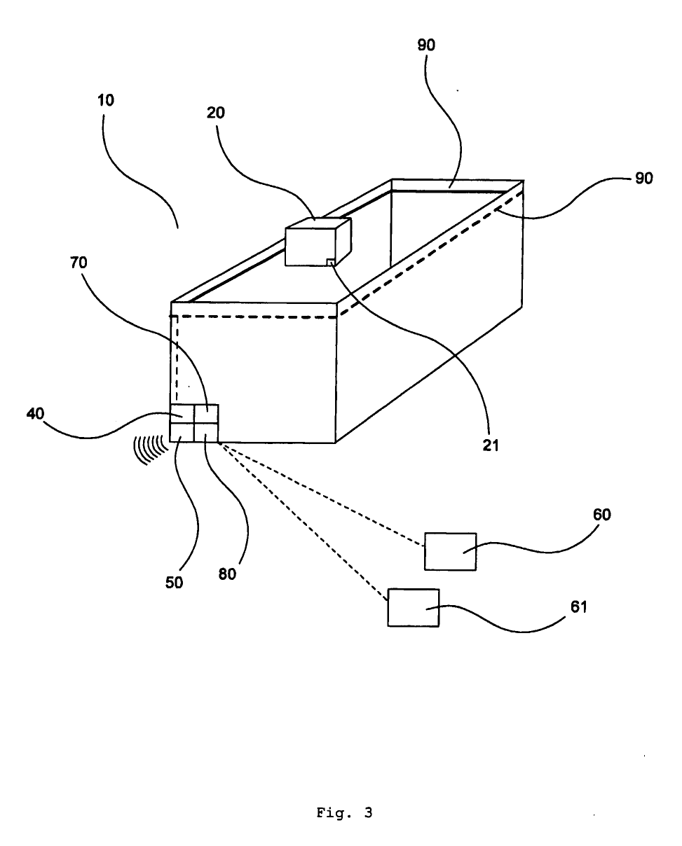

In an especially preferred embodiment of the invention, the container is provided with a goods recording means 90 for recording the goods held in the container 10. Such an arrangement with an antenna that is installed around the opening edge of the container 10 is shown schematically in FIG. 3. For the sake of simplicity, the lid surfaces of the container are not shown here. For purposes of detection by the antenna, the goods 20 are preferably provided with an RFID tag 21 that is read out while an object of interest is being moved past the antenna. In this manner, the object is detected, whereby the antenna 90 is in communication with the data processing unit 40 in which the detection of the goods is recorded. The goods can also have other identification means that can be detected by the antenna, but RFID tags entail the advantage that they have already been applied to many goods for identification purposes and that, if desired, additional data can also be read out.

When the goods are detected, at least the number of objects present in the container is recorded, and the data processing unit also provides computing means that record when an object is taken out of the container. This can be achieved by storing the number of procedures in which the unambiguously identifiable RFID tag that belongs to an object was detected. If the number of detection procedures is an even number, the object is recorded as no longer being located in the container.

In addition to the detection of the goods by an edge antenna of the type shown in FIG. 3, as an alternative, a group detection of the RFID tags 21 of all of the objects in the container can be provided once the filling procedure has been completed. After the filling procedure has been completed, the group detection can be triggered, for example, by an operator. In order to prevent objects from being removed from the container without authorization after the detection, an edge antenna can be additionally provided, which records the removal of an RFID tag that has already been recorded by the group detection.

The detection of the goods 20 by the goods detection means 90 can also provide for reading out of additional data from the appertaining RFID tag 21 to be read out. This can include, for example, information such as the sender or recipient of the object, information about required atmospheric conditions during transportation, a prescribed transportation route or data to identify the object. This data is likewise stored in the data processing unit 40 and, if applicable, processed. For instance, target values for monitoring the container can be generated on the basis of the data.

The container according to the invention with a positioning means 50 allows the association of the position of the container with the detected goods 20. Thus, it can be stored in the data processing unit that a number of certain goods were placed into a container at a given place. The communication module 80 also allows a message to the effect that goods were placed into a container to be transmitted to a message receiving means 61 and/or to a monitoring center 60. If the communication module is a GSM module, it can sent a text message to the monitoring center 60 or to an appropriate receiving device 61. As a result, for example, the sender can receive a confirmation that the correct number and type of goods were placed into a container at a shipping location.

### LIST OF REFERENCE NUMERALS

10 container
11 lid surface
12 capacitive element
20 object, goods
21 RFID tag, identification means
30 sensor means, electrically conductive layer/strip
40 data processing unit
50 positioning means
60 monitoring center
61 message receiving means, message receiving device
70 atmosphere measuring device
80 communication module, interface
90 goods recording means, edge antenna
100 protective sheathing
110 pallet bottom

1-42. (canceled)

43. A method of monitoring a container that holds goods, in which one or more surfaces of the container have an electrically conductive material that acts as a sensor to detect state changes in physical properties of the container, the method comprising:
obtaining state information from the electrically conductive material;
determining a position of the container;
associating the state information with the position of the container;
detecting data about the goods from an RFID tag located on the goods via an antenna that is installed around the opening edge of the container when the goods are loaded into the container and passed by the antenna; and
transmitting at least one of the state information, the position of the container or the data about the goods to a data processing unit.

44. The method according to claim 43, wherein the position of the container is determined by a position sensor on the container.

45. The method according to claim 43, wherein the position of the container is determined by a position sensor on a transportation conveyance on which the container is being transported.

46. The method according to claim 45, comprising transmitting the position of the container to the data processing unit, wherein the data processing unit is disposed on the container.

47. The method according to claim 43, wherein the position of the container is determined by a GSM module, a GPS module and/or a direction-finding transmitter.

48. The method according to claim 47, wherein the direction-finding transmitter, GPS module or GSM module are used as a function of a requisite precision of the position determination, whereby the direction-finding transmitter, GPS module or GSM module can be used alternately or in parallel.

49. The method according to claim 43, wherein the state information obtained from the sensor is compared to one or more target values, whereby a deviation from at least one of the target value is considered to be an alarm.

50. The method according to claim 49, wherein the comparison of the state information is carried out by comparing a measured value of an electrical property of the electrically conductive material with a target value for the electrical property.

51. The method according to claim 49, wherein an alarm does not occur if a state change in physical properties of the container material deviates from a target value if the deviation is associated with a position of the container that is stored as a position in which it is permissible to open the container.

52. The method according to claim 43, comprising:
transmitting the state information obtained from the sensor to a communication module on the container; and
transmitting the state information from the communication module to a message receiving device.

53. The method according to claim 52, wherein the communication module comprises a GSM module.

54. The method according to claim 52, wherein the state information is transmitted from the communication module to the message receiving device when the container has arrived at a destination.

55. The method according to claim 52, wherein the state information is transmitted from the communication module to the message receiving device when the container is on its way to a destination.

56. The method according to claim 52, wherein the state information is transmitted to the message receiving device if a comparison of the state information to a target value shows that a deviation from the target value is considered to be an alarm.

57. The method according to claim 43, wherein the determination of the position of the container and the association of the position with the state information are carried out in the data processing unit on the container or a message receiving device.

58. The method according to claim 43, wherein the container is provided with an atmosphere measuring device that detects an atmosphere inside the container and wherein measured values from the atmosphere measuring device are transmitted to the data processing unit, the data processing unit being disposed on the container.

59. The method according to claim 58, wherein the atmosphere measuring device comprises a temperature and/or moisture sensor whose measured values are transmitted to the data processing unit.

60. The method according to claim 43, wherein at least a number of goods that have been placed into the container is recorded in the data processing unit, the data processing unit being disposed on the container.

61. The method according to claim 60, wherein removal of an item from the container reduces a number of items recorded in the data processing unit, whereby removal of the item from the container is determined when a number of procedures in which an unambiguously identifiable RFID tag belonging to the item being detected is an even number.

62. The method according to claim 60, wherein further data about the goods is acquired.

63. The method according to claim 62, comprising:
transmitting the number of goods and/or the further data about the goods to a communication module; and
sending the number of goods and/or the further data about the goods to a message receiving device.

64. The method according to claim 63, wherein the message receiving device is located in an area of a receiver of the goods or in an area of a monitoring center.

65. A container for holding goods, one or more surfaces of the container having an electrically conductive material that acts as a sensor to detect state information regarding state changes in physical properties of the container, the container comprising:
an antenna disposed around an opening edge of the container, the antenna adapted to detect data about the goods from an RFID tag located on the goods when the goods are loaded into the container and passed by the antenna; and
a data processing unit that receives state information from the sensor, a position of the container and the data about the goods, the data processing unit associating the state information with the position of the container.

66. The container according to claim 65, wherein the position of the container is determined by a positioning sensor located on the container.

67. The container according to claim 65, wherein the position of the container is determined by a positioning sensor located on a transportation conveyance on which the container can be transported.

68. The container according to claim 65, wherein the position of the container is determined by a positioning sensor comprising a GSM module, a GPS module and/or a direction-finding transmitter.

69. The container according to claim 68, wherein the GSM module, the GPS module and/or the direction-finding transmitter may be used alternately or in parallel depending on a requisite precision needed for the determination of the position of the container.

70. The container according to claim 65, wherein the container comprises a communication module that is in communication with the data processing unit.

71. The container according to claim 70, wherein the communication module comprises a GSM module.

72. The container according to claim 65, wherein the data processing unit is adapted to compare the state information to a target state corresponding to physical properties of the container.

73. The container according to claim 72, wherein the data processing unit is adapted to compare a measured electrical property of the electrically conductive material to a target value for the electrical property of the electrically conductive material.

74. The container according to claim 65, comprising an atmosphere measuring device that is adapted to measure an atmosphere inside the container, whereby the atmosphere measuring device is adapted to communicate with the data processing unit.

75. The container according to claim 74, wherein the atmosphere measuring device comprises a temperature and/or moisture sensor.

76. The container according to claim 65, wherein the container comprises a protective sheathing.

77. The container according to claim 65, wherein the data processing unit is adapted to record at least a number of goods placed into the container and/or further data about the goods.

78. The container according to claim 77, wherein the data processing unit is adapted to detect removal of an item from the container if it is determined that a number of procedures in which an unambiguously identifiable RFID tag belonging to the item has been detected an even number of times.

79. A shipping container that is adapted to hold goods, the shipping container having one or more surfaces that have an electrically conductive material that acts as a sensor to detect state changes in physical properties of the container, the shipping container comprising:
means for obtaining state information from the electrically conductive material;
means for determining a position of the container;
means for detecting data about the goods from an RFID tag located on the goods via an antenna that is installed around the opening edge of the container when the goods are loaded into the container and passed by the antenna; and
means for transmitting at least one of the state information, the position of the container or the data about the goods to a data processing unit.
